(19) United States
(12) Patent Application Publication
(10) Pub. No.: US 2024/0320850 A1
(43) Pub. Date: Sep. 26, 2024

(54) METHODS, APPARATUSES, AND NON-TRANSITORY COMPUTER-READABLE STORAGE MEDIA STORING PROGRAMS FOR PROCESSING AN IMAGE

(71) Applicant: NEC CORPORATION, Tokyo (JP)

(72) Inventors: Satoshi YAMAZAKI, Singapore (SG); Wei Jian PEH, Wei Jian (SG); Hui Lam ONG, Singapore (SG); Hong Yen ONG, Singapore (SG)

(73) Assignee: NEC CORPORATION, Minato-ku, Tokyo (JP)

(21) Appl. No.: 18/269,624

(22) PCT Filed: Mar. 23, 2022
(86) PCT No.: PCT/JP2022/013764

§ 371 Date: Jun. 26, 2023

(30) Foreign Application Priority Data
May 5, 2021 (SG) 10202104691X

(51) Int. Cl. G06T 7/73; G06V 10/44

(52) U.S. Cl. CPC G06T 7/73; G06V 10/44

(57) ABSTRACT

Present disclosure provides methods and apparatuses for processing an image. The method comprising: obtaining, by a processor, a projected keypoint and a direct keypoint of a feature of the input image, wherein the projected keypoint comprises a first set of coordinates of the feature projected from a 3D rendering of the input image, and the direct keypoint comprises a second set of coordinates of the feature based on a 2D rendering of the feature; and computing, by the processor, a confidence score based on the projected keypoint and the direct keypoint, wherein a higher confidence score indicates a higher accuracy of the projected and direct keypoints.

### TECHNICAL FIELD

The present invention relates broadly, but not exclusively, to methods and devices for processing an image.

### BACKGROUND ART

Image processing to render 3D objects from 2D images is gaining attention not only in academic research but also in enterprise markets. For example, a 3D human avatar can be generated from a picture of a person for clothes design purposes. The technology is also useful for many applications such as a sports scene analysis, suspicious behavior analysis and so on.

Regression based 3D human and shape estimation such as human mesh recovery (HMR) is one of the ways to estimate and render a human body model from an input image (see NPL1). In this method, an image is analyzed to identify human body shapes that are present in the image. 3D coordinates of vertexes and surfaces of the identified human body shapes are generated, as well as a camera view and angle in 3D coordinates are determined in respect of the identified human body shapes. Thereafter, 2D projected body keypoints (KPTs) can be calculated from these outputs.

### CITATION LIST

### Non Patent Literature

NPL 1: Kanazawa, Angjoo, et al. “End-to-end recovery of human shape and pose.” Proceedings of the IEEE Conference on Computer Vision and Pattern Recognition. 2018

### SUMMARY OF INVENTION

### Technical Problem

Existing technologies of regression based human model fitting have difficulties to declare the confidence level of results i.e., a level of confidence that the result is accurate. In images of crowded places with a plurality of people, not all the human bodies can be identified by HMR and only one human body rendering may be identified and generated as an output. In cases where a person in the image is only partially visible, the resulting output may also be inaccurate. However, there is no way to filter inaccurate results that may occur due to the above scenarios.

Unlike existing 2D human body KPT estimation technologies, HMR has difficulties to learn accurate 2D projected KPTs from training data. HMR can be trained by direct joint regression loss of 2D projected KPT, but the loss does not take much supervised signals from training data as compared to other 2D body KPT training techniques such as KPT heatmap learning.

Herein disclosed are embodiments of a device and methods for processing images that addresses one or more of the above problems.

Furthermore, other desirable features and characteristics will become apparent from the subsequent detailed description and the appended claims, taken in conjunction with the accompanying drawings and this background of the disclosure.

### Solution to Problem

In a first aspect, the present disclosure provides a method of processing an input image, comprising: obtaining, by a processor, a projected keypoint and a direct keypoint of a feature of the input image, wherein the projected keypoint comprises a first set of coordinates of the feature projected from a 3D rendering of the input image, and the direct keypoint comprises a second set of coordinates of the feature based on a 2D rendering of the feature; and computing, by the processor, a confidence score based on the projected keypoint and the direct keypoint, wherein a higher confidence score indicates a higher accuracy of the projected and direct keypoints.

In a second aspect, the present disclosure provides an apparatus for processing an input image, comprising: a memory in communication with a processor, the memory storing a computer program recorded therein, the computer program being executable by the processor to cause the apparatus at least to: obtain a projected keypoint and a direct keypoint of a feature of the input image, wherein the projected keypoint comprises a first set of coordinates of the feature projected from a 3D rendering of the input image, and the direct keypoint comprises a second set of coordinates of the feature based on a 2D rendering of the feature; and compute a confidence score based on the projected keypoint and the direct keypoint, wherein a higher confidence score indicates a higher accuracy of the projected and direct keypoints.

In a third aspect, the present disclosure provides a system for processing an input image, comprising: the apparatus according to the second aspect, and at least one image capturing device.

In a fourth aspect, the present disclosure provides a method of training a model rendering for an input image, comprising: obtaining, by a processor, a projected keypoint and a direct keypoint of each feature of the input image, wherein the projected keypoint comprises a first set of coordinates of each feature projected from a 3D rendering of the input image, and the direct keypoint comprises a second set of coordinates of each feature based on a 2D rendering of each feature; computing, by the processor, a consistency loss value of each feature based on the respective projected keypoint and direct keypoint; calculating, by the processor, a total loss based on the consistency loss value of each feature and ground truth data of the input image, and deriving a total loss error based on the total loss; and propagating, by the processor, the total loss error to the model rendering.

In a fifth aspect, the present disclosure provides an apparatus for training a model rendering for an input image, comprising: a memory in communication with a processor, the memory storing a computer program recorded therein, the computer program being executable by the processor to cause the apparatus at least to: obtain a projected keypoint and a direct keypoint of each feature of the input image, wherein the projected keypoint comprises a first set of coordinates of each feature projected from a 3D rendering of the input image, and the direct keypoint comprises a second set of coordinates of each feature based on a 2D rendering of each feature; compute a consistency loss value of each feature based on the respective projected keypoint and the direct keypoint; calculate a total loss based on the consistency loss value of each feature and ground truth data of the input image, and deriving a total loss error based on the total loss; and propagate the total loss error to the model rendering.

In a sixth aspect, the present disclosure provides a system for training a model rendering for an input image, comprising: the apparatus according to the fifth aspect, and at least one image capturing device.

### BRIEF DESCRIPTION OF DRAWINGS

The accompanying Figures, where like reference numerals may refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the invention will be better understood and readily apparent to one of ordinary skill in the art from the following written description, by way of example only, and in conjunction with the drawings, in which:

FIG. 1 shows an example illustration of a process of generating a 3D mesh from a 2D image according to various embodiments of the present disclosure.

FIG. 2A depicts illustration of inaccurate 3D human body models that may be generated due to the presence of occluded persons and due to lack of visibility of human body keypoints respectively.

FIG. 2B depicts illustration of an inaccurate 3D human body model that may be generated due to the presence of an occluded person and due to lack of visibility of human body keypoints respectively.

FIG. 3 illustrates a keypoint heatmap estimation according to various embodiments of the present disclosure.

FIG. 4 illustrates a flow diagram for calculating a confidence score based on 2D pose visibility and consistency according to various embodiments of the present disclosure.

FIG. 5 depicts an illustration of how an obtained confidence score may be compared to a threshold value according to an embodiment of the present disclosure.

FIG. 6 illustrates a component diagram for confidence score calculation according to various embodiments of the present disclosure.

FIG. 7 illustrates an example flowchart for confidence score calculation according to various embodiments of the present disclosure.

FIG. 8 depicts an illustration of an extended HMR network architecture with calculation of consistency loss according to various embodiments of the present disclosure.

FIG. 9 illustrates a component diagram for model training calculations according to various embodiments of the present disclosure.

FIG. 10 illustrates an example flowchart for training a model rendering of a training image according to various embodiments of the present disclosure.

FIG. 11 depicts a block diagram illustrating a system for processing an input image according to various embodiments of the present disclosure.

FIG. 12 depicts an exemplary computing device that may be used to execute the methods of the earlier figures.

### DESCRIPTION OF EMBODIMENTS

### Terms Description

Keypoints (KPTs) refer to points of body parts, such as top of a head, shoulder, elbow and other similar body parts or joints. Possible keypoints of a human body can also include body parts like a nose, inner part of an eye, outer part of an eye, ear, right and left side of a mouth, wrist, each knuckle, right and left hips, knees, ankles, heels, feet, toes and other similar body parts or joints.

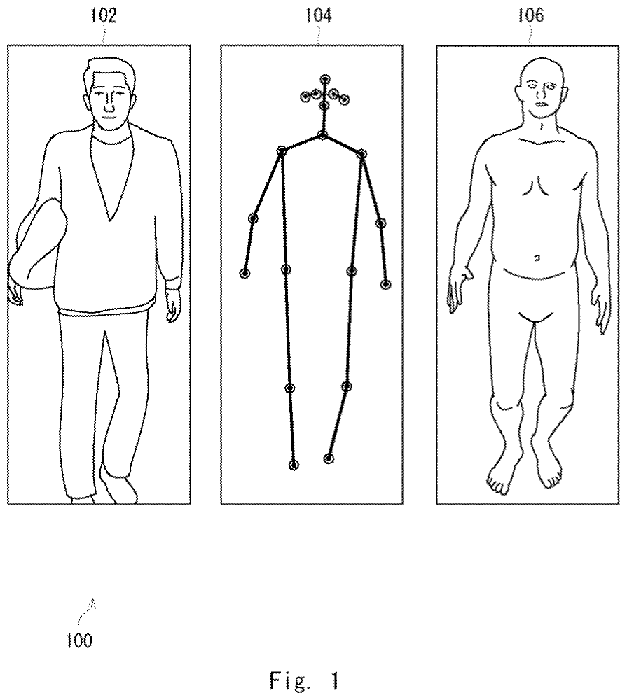

3D pose and shape regressor refers to a module or process which estimates three-dimensional locations of human meshes (vertexes and surfaces), and camera parameters including 3D location of a camera and/or angles to render the 3D human meshes that align with a 2D body shape and pose that is identified in the input image. The module may be, for example, a trainable neural network model. An example of a 3D human pose and shape estimation process is illustrated in FIG. 1, wherein an input image 102 is processed to obtain keypoints that are representative of the person shown in the image 102. These keypoints are used to estimate a 3D mesh 104 that align with the body shape and pose of the person shown in the image 102. A texture overlay may then be applied to the 3D mesh 104 to form 3D model 106. It will be appreciated that further textural improvements are possible from 3D model 106. The generated 3D model 106 (or improved versions thereof) may be used as an avatar for various applications such as designer tools for clothes design, surveillance applications, suspicious behaviour analysis, gaming, and other similar applications.

Feature—As commonly used in the art, a feature may be any vector of values which may not be readable/interpreted by humans. A feature may be extracted from, for example, a 2D image. The process of feature extraction from an image refers to a process which quantifies features of target objects in images. Keypoints may be generated from the extracted feature for human pose estimation and/or human mesh recovery. The extracted feature may also be used in, for example, a trainable neural network model to improve human pose estimation.

Error propagation or back propagation refers to an algorithm to fit neural network models. Back propagation computes a gradient of a loss function with respect to weights of a network model for a single input-output example, and does so efficiently, unlike a naive direct computation of the gradient with respect to each weight individually.

Ground truth data refer to input-output examples of machine learning models. In the case of HMR model training, the input and output are typically an image and 3D human meshes, respectively. Usually loss function is computed by the input-output example. By minimizing the loss function through error propagation, machine learning model tends to output similar results from the input.

### EMBODIMENTS

Where reference is made in any one or more of the accompanying drawings to steps and/or features, which may have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which form public knowledge through their use. Such should not be interpreted as a representation by the present inventor(s) or the patent applicant that such devices in any way form part of the common general knowledge in the art.

End-to-end HMR is a form of regression based 3D human pose and shape estimation, which is based upon processing an image to generate a human body model that best fits an identified human body shape in the image. The input is an image in which a human body is expected to be in, and the outputs are 3D coordinates of vertexes and surfaces of the identified human body, as well as a camera location and angles in three-dimensional coordinates relative to the identified human body. Thereafter, 2D projected keypoints (i.e., keypoints that are defined on a 2D plane with for example X-Y coordinates) may be calculated from these outputs. In an example process for end-to-end recovery of human shape and pose, an input image may be processed regressively to estimate and determine outputs such as 3D coordinates of vertexes and surfaces of the identified human body, as well as a camera location and angles in three-dimensional coordinates relative to the identified human body in the input image. A 3D human body model may be generated based on these outputs. Keypoints then may be projected from the 3D human body model onto a 2D plane perspective to form 2D projected keypoints.

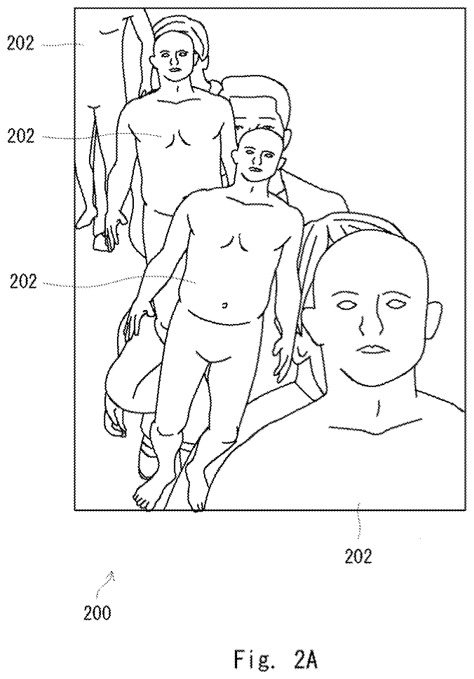

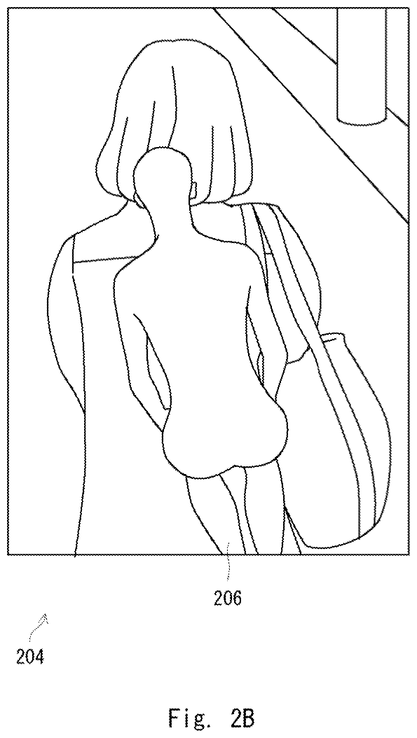

However, existing technologies of regression based human model fitting such as those described above typically has difficulties in outputting accurate human body models especially in challenging situations such as images showing more than one person, where the human bodies may be occluded or lack visibility. For example, FIG. 2A shows inaccurate 3D human body models 202 that may be generated due to the presence of occluded persons captured in image 200, and FIG. 2B shows an inaccurate 3D human body model 206 that may be generated due to the lack of visibility of human body keypoints for the person captured in image 204. There is generally a difficulty in ascertaining a confidence level of results obtained from regression based human model fitting that the results are accurate. Further, there is no way to filter inaccurate results due to lack of visibilities of human body keypoints.

Accuracy of projected 2D keypoints from regression based human model fitting is also an issue. Unlike existing 2D human body keypoint estimation technologies, HMR has difficulties in learning accurate 2D projected keypoints from training data. While HMR can be trained by direct joint regression loss of 2D projected KPT, the loss does not take much supervised signals from training data as compared to other 2D body KPT training techniques such as KPT heatmap learning.

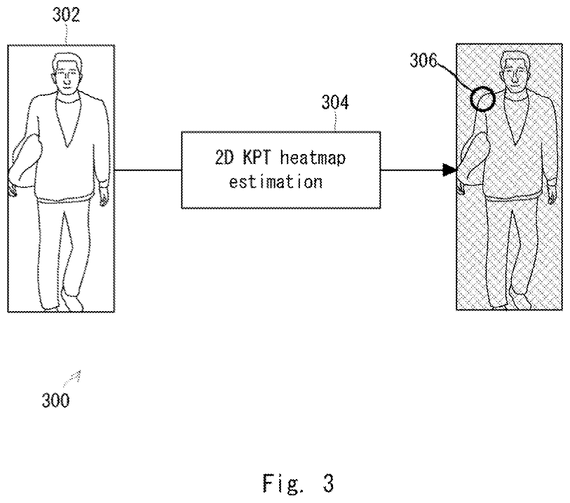

FIG. 3 depicts a flow diagram 300 illustrating a KPT heatmap estimation, in which input image 302 is processed via a 2D keypoint estimation process 304 to identify heatmaps for each keypoint of the input image 302, for example heatmap 306. A heatmap may be generalized as a map with areas of varying probabilities, wherein the location of the keypoint associated with the heatmap can be estimated by the coordinates that have the highest probability over the map of probabilities. Further, a visibility or confidence value may also be derived from the heatmap, wherein the visibility or confidence value may be the highest probability value of the map. Currently, there is no way to utilize 2D training methods such as heatmap learning technique with HMR.

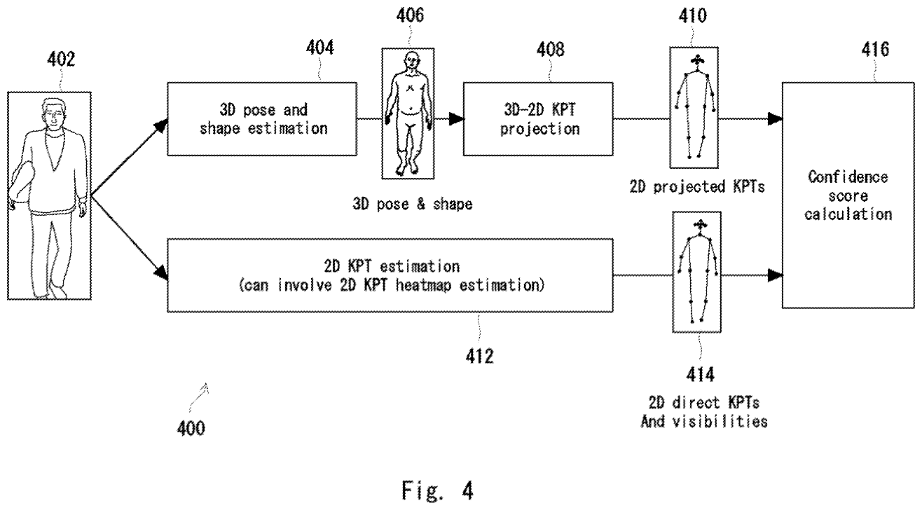

FIG. 4 illustrates a flow diagram 400 for calculating a confidence score based on 2D pose visibility and consistency to address the above-mentioned issues. This is based on the premise that visible keypoints tend to have higher confidence values in terms of accuracy, and that there is a higher confidence that the results are accurate if the results are consistent among different methods. In flow diagram 400, a projected keypoint is obtained for a feature of an input image 402. The projected keypoint may be obtained by applying a 3D pose and shape estimation process 404 (for example, by 3D pose and shape regression techniques as described above or any other 3D estimation techniques known in the art) on the feature of the input image 402 using to generate a 3D rendering 406, and then applying a 3D-2D keypoint projection process 408 on the 3D rendering 406 to obtain coordinates of the projected keypoint associated with the feature. The projected keypoint comprises a set of coordinates of the feature that is projected from the 3D rendering 406 of the input image 402. A plurality of projected keypoints 410 are obtainable from a plurality of features of the input image 402.

Further, a direct keypoint is obtained based on a 2D rendering of a feature of the input image 402. Specifically, the direct keypoint may be obtained by applying a 2D keypoint estimation process 412 (for example, by using heatmap estimation as described in FIG. 3 or any other 2D estimation techniques known in the art) on the feature of the input image 402. The direct keypoint comprises a set of coordinates of the feature that is based from the 2D rendering of the input image 402. In the case of the 2D rendering being a heatmap rendering, the heatmap rendering comprises one or more set of coordinates for the feature, each of the one or more set of coordinates having a probability value, and wherein the set of coordinates of the direct keypoint has a highest probability value among the one or more set of coordinates. A plurality of direct keypoints 414 are obtainable from a plurality of features of the input image 402.

Thereafter, at 416, a confidence score is computed based on the projected keypoint and the direct keypoint, wherein a higher confidence score indicates a higher accuracy of the projected and direct keypoints. The confidence score may, for example, be computed by applying a formula as shown below:

$${C}_{i} = {v}_{i} exp ( - {α ( {J}_{i}^{proj} - {J}_{i}^{direct} )}^{2} )$$

i: index of keypoints
vᵢ: visibility of ith keypoint
Jᵢ^{proj}: projected position of ith keypoint
Jᵢ^{direct}: directly estimated position of ith keypoint
α: a tuning parameter

The above formula is based on the obtained positions or coordinates of the projected and direct keypoints, as well as a visibility value v of the direct keypoint. The above formula first calculates a consistency score based on the projected keypoint and direct keypoint, then calculates a confidence score by multiplying the consistency score with the visibility value v. The tuning parameter a in the consistency score calculation may be a pre-fixed value during the calculation which can be manually tuned based on experiments to get more accurate scores. The visibility value v may be obtained during the 2D keypoint estimation process 412. For example, if a heatmap estimation is used for the process 412, the visibility value may be the highest probability value of the heatmap for the associated feature. It will be appreciated that other 2D estimation techniques known in the art may be utilized with their corresponding way of obtaining the visibility value. By applying the above formula, a confidence score is obtained which advantageously indicates a degree of accuracy of the projected and direct keypoints.

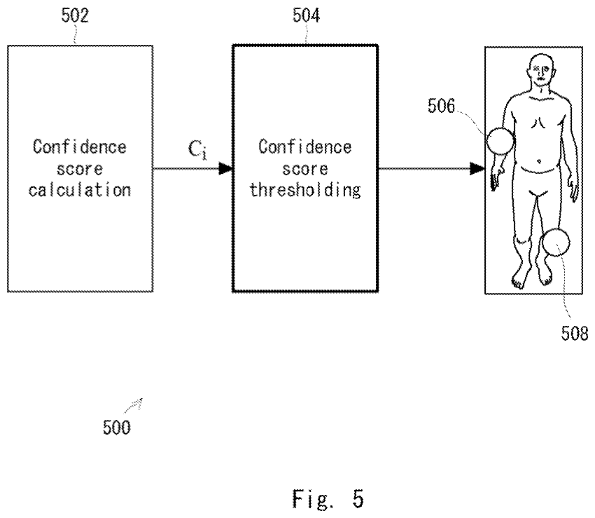

Further, the obtained confidence score may be compared to a threshold value as shown in FIG. 5. For example, after a confidence score calculation process 502 is completed, confidence score is obtained and compared with a confidence score threshold value at thresholding process 504. If the confidence score is lower than the threshold value for a feature 506 of an input image, the projected and direct keypoints associated with feature 506 may be deemed inaccurate. If the confidence score is higher than or equal to the threshold value for a feature 508 of the input image, the projected and direct keypoints associated with feature 508 may be deemed accurate. Advantageously, this enables inaccurate results to be identified and rejected.

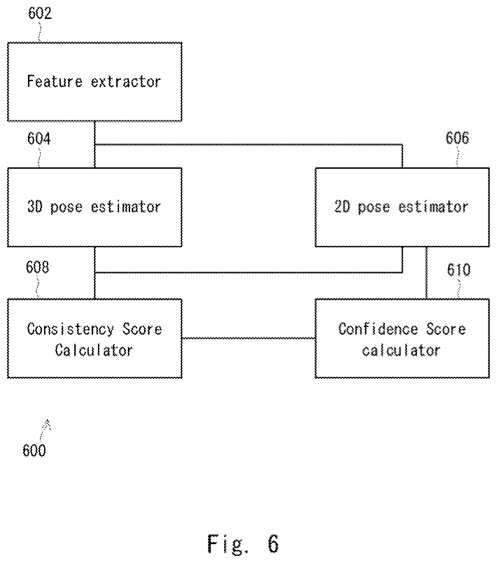

FIG. 6 illustrates a component diagram 600 for the confidence score calculation as described above. A feature extractor 602 may be utilized to extract a feature from an input image. 3D pose estimator 604 applies a 3D estimation technique known in the art to obtain a projected keypoint for the extracted feature, and the 2D pose estimator 606 applies a 2D estimation technique known in the art to obtain a direct keypoint for the extracted feature. Consistency score calculator 608 calculates and obtains a consistency score based on the projected keypoint and the direct keypoint, such as by applying the consistency calculation portion of the formula described above for process 416. The confidence score calculator 610 then calculates and obtains a confidence score based on the consistency score and a visibility value of the direct keypoint. The visibility value may be calculated by the 2D pose estimator 606 and input into the confidence score calculator 610, which then applies a formula based on the visibility value and the consistency score. The formula may be that described above for process 416, wherein the consistency score is multiplied with the visibility value to obtain the confidence score.

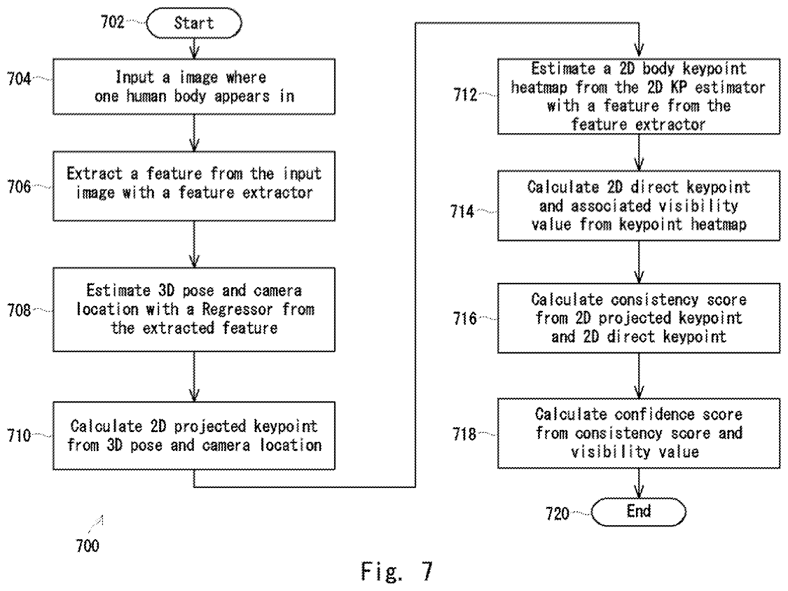

FIG. 7 illustrates an example flowchart 700 for confidence score calculation. The process begins at step 702. At step 704, an image wherein a human body appears in is input. At step 706, a feature is extracted from the input image with a feature extractor. At step 708, a 3D pose and a camera location is estimated from the extracted feature with a 3D pose and shape regressor. At step 710, a 2D projected keypoint is calculated from the estimated 3D pose and camera location. At step 712, a 2D body keypoint heatmap is estimated from the extracted feature with a 2D keypoint estimator. At step 714, a 2D direct keypoint and associated visibility value are obtained from the keypoint heatmap. At step 716, a consistency score is calculated from the 2D projected keypoint and the 2D direct keypoint. At step 718, a confidence score is calculated from the consistency score and visibility value. The process then ends at step 720.

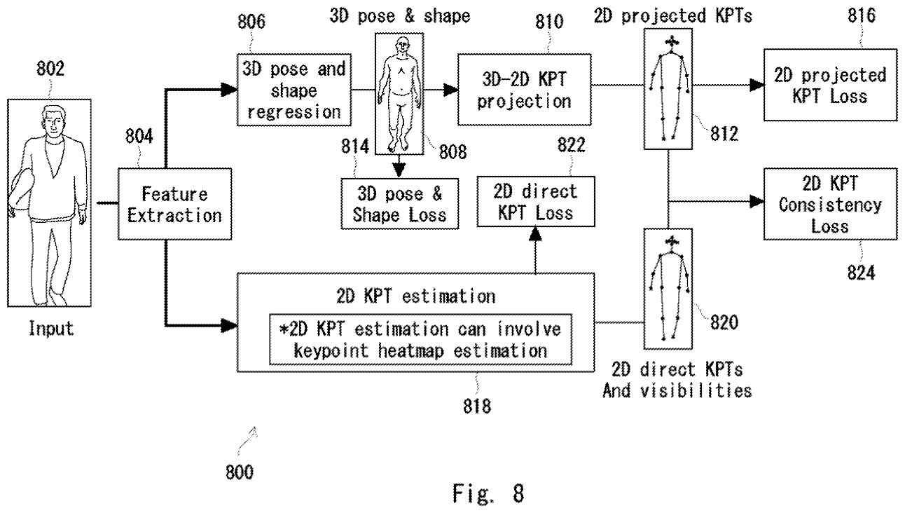

The techniques described above for comparing projected keypoints from 3D pose and shape regression techniques and direct keypoints from 2D estimation techniques can be further extended to HMR network architecture with calculation of consistency loss, as shown in illustration 800 of FIG. 8. In this architecture, one feature extractor is shared between a 2D keypoint estimator and a 3D pose and shape estimator. The basic premise for this architecture is that results that are consistent with each other despite being obtained from different techniques (i.e., 3D estimation and 2D estimation) can be considered to be more accurate. This architecture may be utilized for training a model rendering for an input image to advantageously improve image processing results for obtaining accurate keypoints through deep learning.

In FIG. 8, an input image 802 undergoes a feature extraction process 804 by a feature extractor to obtain an extracted feature. The input image 802 comprises ground truth data including both 2D and 3D keypoint data which may be utilized for minimising total loss when training a model rendering for the image 802. A projected keypoint is obtained for a feature of an input image 802. The projected keypoint may be obtained by applying a 3D pose and shape estimation process 806 (for example, by 3D pose and shape regression techniques as described above or any other 3D estimation techniques known in the art) on the extracted feature of the input image 802 using to generate a 3D rendering 808, and then applying a 3D-2D keypoint projection process 810 on the 3D rendering 808 to obtain coordinates of the projected keypoint associated with the feature. The projected keypoint comprises a set of coordinates of the feature that is projected from the 3D rendering 808 of the input image 802. A plurality of projected keypoints 812 are obtainable from a plurality of extracted features of the input image 802. Further, the 3D rendering undergoes a 3D pose and shape loss calculation process 814 to obtain a 3D keypoint loss L3D for each extracted feature, and a 2D projected keypoint loss Lproj is calculated for each feature through a 2D projected keypoint loss calculation process 816. The 3D keypoint loss corresponds to errors between positions of the estimated 3D keypoint and the ground truth 3D keypoint for the associated extracted feature, and the 2D projected keypoint loss corresponds to errors between positions of the projected keypoint and the ground truth 2D keypoint.

A direct keypoint is also obtained based on a 2D rendering of the extracted feature of the input image 802. Specifically, the direct keypoint may be obtained by applying a 2D keypoint estimation process 818 (for example, by using heatmap estimation as described in FIG. 3 or any other 2D estimation techniques known in the art) on the extracted feature of the input image 802. The direct keypoint comprises a set of coordinates of the feature that is based from the 2D rendering of the input image 802. In the case of the 2D rendering being a heatmap rendering, the heatmap rendering comprises one or more set of coordinates for the feature, each of the one or more set of coordinates having a probability value, and wherein the set of coordinates of the direct keypoint has a highest probability value among the one or more set of coordinates A plurality of direct keypoints 820 are obtainable from a plurality of extracted features of the input image 802. Further, the 2D rendering undergoes a 2D direct keypoint loss calculation process 822 to obtain a 2D direct keypoint loss L2D for each extracted feature. The 2D direct keypoint loss corresponds to errors between positions of the direct keypoint and ground truth 2D keypoint.

Thereafter, at 824, a consistency loss value is computed based on the projected keypoint and the direct keypoint, wherein a lower consistency loss value indicates a higher accuracy of the projected and direct keypoints. The confidence score Lc may, for example, be computed by applying a formula as shown below:

$${L}_{C} = {\sum }_{i} {{v}_{i} ( {J}_{i}^{proj} - {J}_{i}^{direct} )}^{2}$$

The above formula is based on the obtained positions or coordinates of the projected and direct keypoints, as well as a visibility value v of the direct keypoint. The above formula first calculates a consistency loss based on the projected keypoint, direct keypoint and the associated visibility value v, and then performs a summation for all consistency loss values obtained for the plurality of extracted features. The visibility value v may be obtained during the 2D keypoint estimation process 818. For example, if a heatmap estimation is used for the process 818, the visibility value may be the highest probability value of the heatmap for the associated feature. It will be appreciated that other 2D estimation techniques known in the art may be utilized with their corresponding way of obtaining the visibility value. By applying the above formula, a consistency loss value is obtained which advantageously indicates a degree of accuracy of the projected and direct keypoints.

Furthermore, the consistency loss value may then be used for calculation of a total loss L_{Total}. The training process that utilizes the architecture as shown in FIG. 8 seeks to minimise total loss L_{Total}. L_{Total} may be obtained, for example, by applying the following formula:

$${L}_{Total} = {w}_{3 D} {L}_{3 D} + {w}_{2 D}^{proj} {L}_{2 D}^{proj} + {w}_{2 D}^{direct} {L}_{2 D}^{direct} + {w}_{C} {L}_{C}$$

In the above formula, weights w are applied to each of the 3D pose and shape loss L3D, 2D projected keypoint loss Lproj, 2D direct loss L2D and consistency loss Lc and summed up to obtain total loss L_{Total}. The weights w may be pre-fixed values during the model training, and the weight values may be manually tuned for each of the 3D pose and shape loss L3D, 2D projected keypoint loss Lproj, 2D direct loss L2D and consistency loss Lc based on experiments in order to train and obtain a more accurate model. By minimising the total loss L_{Total} by the training process, the overall accuracy of model rendering for input image 802 can be advantageously improved.

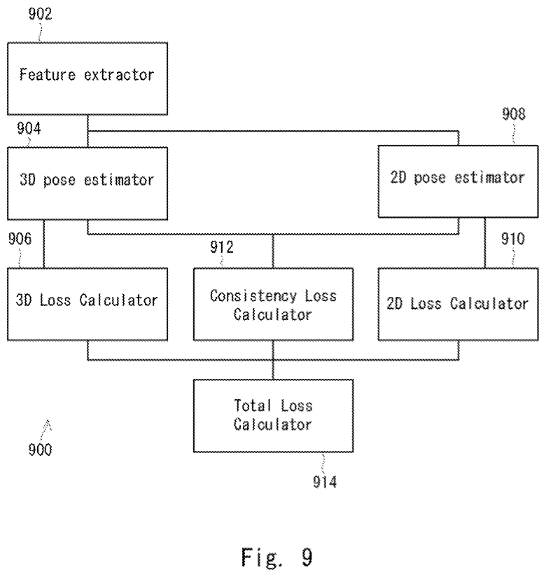

FIG. 9 illustrates a component diagram 900 for the model training calculations as described above. A feature extractor 902 may be utilized to extract a feature from an input image. 3D pose estimator 904 applies a 3D estimation technique known in the art to obtain a 3D keypoint and a 2D projected keypoint for the extracted feature. 3D loss calculator 906 calculates a 3D keypoint loss based on the 3D keypoint and 3D ground truth data of the input image, as well as calculate 2D projected keypoint loss based on the 2D projected keypoint and 2D ground truth data of the input image. 2D pose estimator 908 applies a 2D estimation technique known in the art to obtain a direct keypoint for the extracted feature. 2D loss calculator 910 calculates and obtains 2D direct keypoint loss based on the 2D direct keypoint and 2D ground truth data of the input image. Consistency loss calculator 912 calculates and obtains a consistency loss based on the 2D projected keypoint, the 2D direct keypoint and visibility value of the direct keypoint for each extracted feature, such as by applying the formula described above for process 824. The visibility value may be calculated by the 2D pose estimator 908 and input into the consistency loss calculator 912, which then applies the above-mentioned formula to obtain the consistency loss. Lastly, total loss calculator 914 calculates and obtains a total loss value by, for example, applying the total loss formula as described earlier with weights applied to each of the 3D keypoint loss, 2D projected keypoint loss, 2D direct keypoint loss and consistency loss as inputs, and summed up to obtain total loss. The weights may be pre-fixed values during the model training, and the weight values may be manually tuned for each of the 3D keypoint loss, 2D projected keypoint loss, 2D direct keypoint loss and consistency loss based on experiments in order to train and obtain a more accurate model.

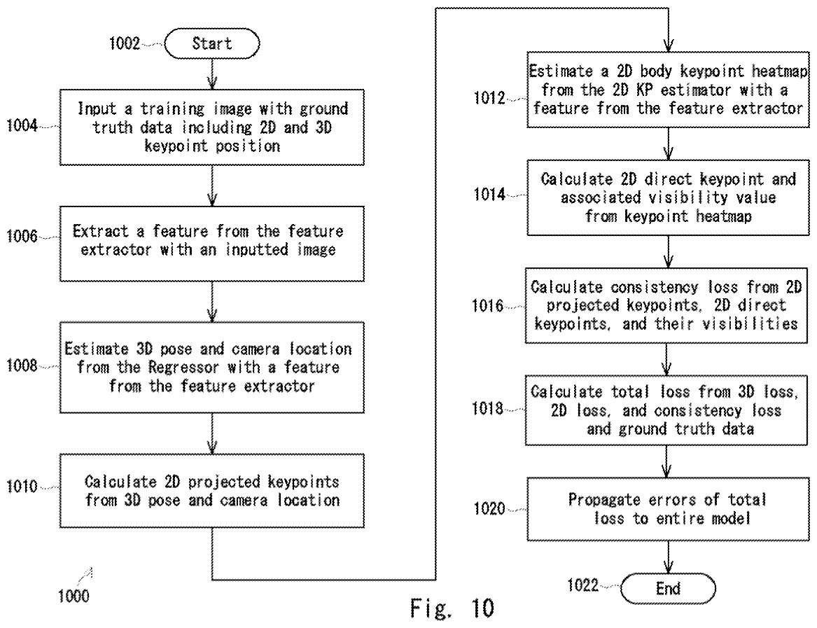

FIG. 10 illustrates an example flowchart 1000 for training a model rendering of a training image. The process begins at step 1002. At step 1004, the training image with ground truth data including 2D and 3D keypoint position is input. At step 1006, a feature is extracted from the input image with a feature extractor. At step 1008, a 3D pose and a camera location is estimated from the extracted feature with a 3D pose and shape regressor, obtaining a 3D keypoint for the extracted feature. At step 1010, a 2D projected keypoint is calculated from the estimated 3D pose and camera location. At step 1012, a 2D body keypoint heatmap is estimated from the extracted feature with a 2D keypoint estimator. At step 1014, a 2D direct keypoint and associated visibility value are obtained from the keypoint heatmap. At step 1016, a consistency loss is calculated from the 2D projected keypoint, the 2D direct keypoint and associated visibility value for all extracted features. At step 1018, a total loss is calculated based on weighted values of the 3D keypoint loss, 2D projected keypoint loss, 2D direct keypoint loss and consistency loss as inputs, and summed up to obtain total loss. At step 1020, errors of the obtained total loss are propagated to the entire model. The process then ends at step 1022.

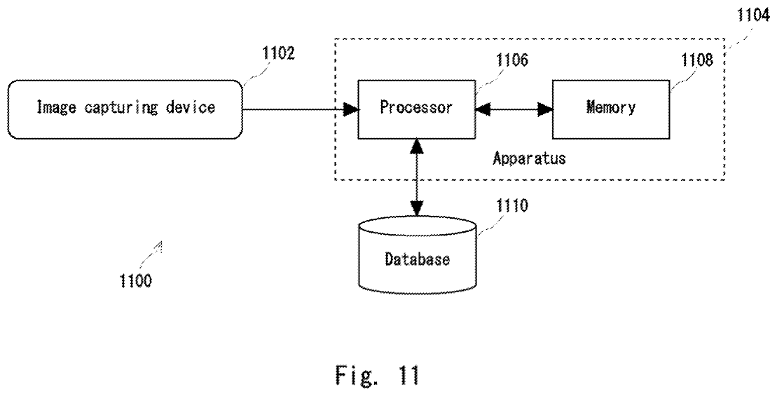

FIG. 11 depicts a block diagram illustrating a system 1100 for processing an input image according to various embodiments. In an example, the managing of image input is performed by at least an image capturing device 1102 and an apparatus 1104. The system 1100 comprises an image capturing device 1102 in communication with the apparatus 1104. In an implementation, the apparatus 1104 may be generally described as a physical device comprising at least one processor 1106 and at least one memory 1108 including computer program code. The at least one memory 1108 and the computer program code are configured to, with the at least one processor 1106, cause the physical device to perform the operations described in FIGS. 7 and/or 10. The processor 1106 is configured to receive an image from the image capturing device 1102 or to retrieve an image from a database 1110.

The image capturing device 1102 may be a device in which an image can be input. For example, a digital image can be input, or a physical copy of an image can be input such that the image is scanned and the scanned image being used as an input. The image capturing device 1102 may also be configured to receive training image with ground truth data including 2D and 3D keypoint information. The image capturing device may also be a camera with which a photograph can be taken and used as an input image for the apparatus 1104.

The apparatus 1104 may be configured to communicate with the image capturing device 1102 and the database 1110. In an example, the apparatus 1104 may receive, from the image capturing device 1102, or retrieve from the database 1110, an input image, and after processing by the processor 1106 in apparatus 1104, calculate a confidence score based on a projected keypoint and a direct keypoint of an extracted feature of the input image, wherein a higher confidence score indicates a higher accuracy of the projected and direct keypoints. The apparatus 1104 may also be configured to calculate a total loss based on a consistency loss value of each extracted feature and ground truth data of the input image, derive a total loss error based on the total loss, and propagate the total loss error to a model rendering.

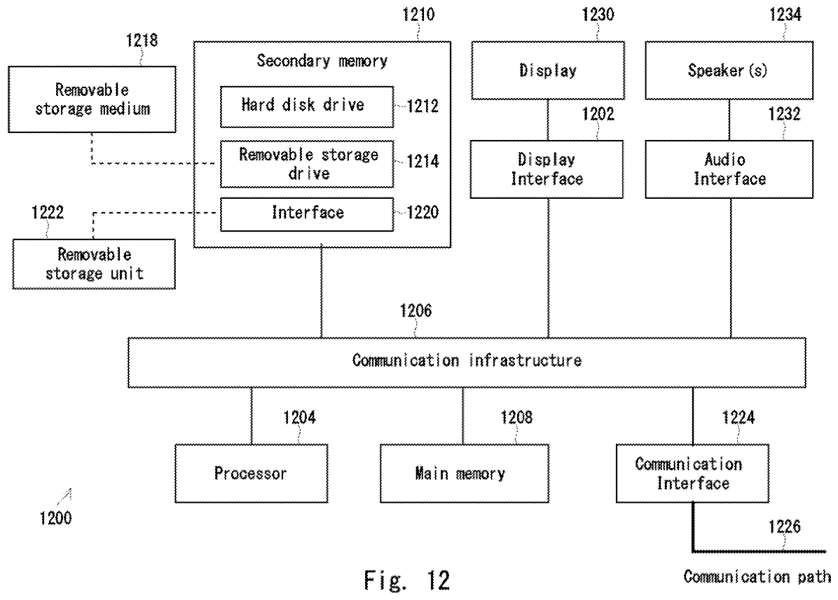

FIG. 12 depicts an exemplary computing device 1200, hereinafter interchangeably referred to as a computer system 1200 or as a device 1200, where one or more such computing devices 1200 may be used to implement the system 1100 shown in FIG. 11 or the method of the earlier figures. The following description of the computing device 1200 is provided by way of example only and is not intended to be limiting.

As shown in FIG. 12, the example computing device 1200 includes a processor 1204 for executing software routines. Although a single processor is shown for the sake of clarity, the computing device 1200 may also include a multi-processor system. The processor 1204 is connected to a communication infrastructure 1206 for communication with other components of the computing device 1200. The communication infrastructure 1206 may include, for example, a communications bus, cross-bar, or network.

The computing device 1200 further includes a primary memory 1208, such as a random access memory (RAM), and a secondary memory 1210. The secondary memory 1210 may include, for example, a storage drive 1212, which may be a hard disk drive, a solid state drive or a hybrid drive and/or a removable storage drive 1214, which may include a magnetic tape drive, an optical disk drive, a solid state storage drive (such as a USB flash drive, a flash memory device, a solid state drive or a memory card), or the like. The removable storage drive 1214 reads from and/or writes to a removable storage medium 1218 in a well-known manner. The removable storage medium 1218 may include magnetic tape, optical disk, non-volatile memory storage medium, or the like, which is read by and written to by removable storage drive 1214. As will be appreciated by persons skilled in the relevant art(s), the removable storage medium 1218 includes a computer readable storage medium having stored therein computer executable program code instructions and/or data.

In an alternative implementation, the secondary memory 1210 may additionally or alternatively include other similar means for allowing computer programs or other instructions to be loaded into the computing device 1200. Such means can include, for example, a removable storage unit 1222 and an interface 1220. Examples of a removable storage unit 1222 and interface 1220 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1222 and interfaces 1220 which allow software and data to be transferred from the removable storage unit 1222 to the computer system 1200.

The computing device 1200 also includes at least one communication interface 1224. The communication interface 1224 allows software and data to be transferred between computing device 1200 and external devices via a communication path 1226. In various embodiments of the inventions, the communication interface 1224 permits data to be transferred between the computing device 1200 and a data communication network, such as a public data or private data communication network. The communication interface 1224 may be used to exchange data between different computing devices 1200 which such computing devices 1200 form part an interconnected computer network. Examples of a communication interface 1224 can include a modem, a network interface (such as an Ethernet card), a communication port (such as a serial, parallel, printer, GPIB, IEEE 1394, RJ45, USB), an antenna with associated circuitry and the like. The communication interface 1224 may be wired or may be wireless. Software and data transferred via the communication interface 1224 are in the form of signals which can be electronic, electromagnetic, optical or other signals capable of being received by communication interface 1224. These signals are provided to the communication interface via the communication path 1224.

As shown in FIG. 12, the computing device 1200 may further include a display interface 1202 which performs operations for rendering images to an associated display 1230 and an audio interface 1232 for performing operations for playing audio content via associated speaker(s) 1234.

As used herein, the term “computer program product” (or computer readable medium, which may be a non-transitory computer readable medium) may refer, in part, to removable storage medium 1218, removable storage unit 1222, a hard disk installed in storage drive 1212, or a carrier wave carrying software over communication path 1226 (wireless link or cable) to communication interface 1224. Computer readable storage media (or computer readable media) refers to any non-transitory, non-volatile tangible storage medium that provides recorded instructions and/or data to the computing device 1200 for execution and/or processing. Examples of such storage media include magnetic tape, CD-ROM, DVD, Blu-ray Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1200. Examples of transitory or non-tangible computer readable transmission media that may also participate in the provision of software, application programs, instructions and/or data to the computing device 1200 include radio or infra-red transmission channels as well as a network connection to another computer or networked device, and the Internet or Intranets including e-mail transmissions and information recorded on Websites and the like.

The computer programs (also called computer program code) are stored in primary memory 1208 and/or secondary memory 1210. Computer programs can also be received via the communication interface 1224. Such computer programs, when executed, enable the computing device 1200 to perform one or more features of embodiments discussed herein. In various embodiments, the computer programs, when executed, enable the processor 1204 to perform features of the above-described embodiments. Accordingly, such computer programs represent controllers of the computer system 1200.

Software may be stored in a computer program product and loaded into the computing device 1200 using the removable storage drive 1214, the storage drive 1212, or the interface 1220. The computer program product may be a non-transitory computer readable medium. Alternatively, the computer program product may be downloaded to the computer system 1200 over the communications path 1226. The software, when executed by the processor 1204, causes the computing device 1200 to perform functions of embodiments described herein.

It is to be understood that the embodiment of FIG. 12 is presented merely by way of example. Therefore, in some embodiments one or more features of the computing device 1200 may be omitted. Also, in some embodiments, one or more features of the computing device 1200 may be combined together. Additionally, in some embodiments, one or more features of the computing device 1200 may be split into one or more component parts.

It will be appreciated by a person skilled in the art that numerous variations and/or modifications may be made to the present invention as shown in the specific embodiments without departing from the spirit or scope of the invention as broadly described. For example, the above description mainly presenting alerts on a visual interface, but it will be appreciated that another type of alert presentation, such as sound alert, can be used in alternate embodiments to implement the method. Some modifications, e.g., adding an access point, changing the log-in routine, etc. may be considered and incorporated. The present embodiments are, therefore, to be considered in all respects to be illustrative and not restrictive.

For example, the whole or part of the example embodiments disclosed above can be described as, but not limited to, the following supplementary notes.

### (Supplementary Note 1)

A method of processing an input image, comprising:
obtaining, by a processor, a projected keypoint and a direct keypoint of a feature of the input image, wherein the projected keypoint comprises a first set of coordinates of the feature projected from a 3D rendering of the input image, and the direct keypoint comprises a second set of coordinates of the feature based on a 2D rendering of the feature; and
computing, by the processor, a confidence score based on the projected keypoint and the direct keypoint, wherein a higher confidence score indicates a higher accuracy of the projected and direct keypoints.

### (Supplementary Note 2)

The method of processing the input image according to Supplementary Note 1, further comprising obtaining a visibility value of the direct keypoint, wherein the visibility value is computed by the 2D rendering, and wherein computing the confidence score further comprises applying a formula with the visibility value, the projected keypoint and the direct keypoint.

### (Supplementary Note 3)

The method of processing the input image according to Supplementary Note 2, wherein the 2D rendering is a heatmap rendering, wherein the heatmap rendering of the feature comprises one or more set of coordinates for the feature, each of the one or more set of coordinates having a probability value, and wherein the second set of coordinates has a highest probability value among the one or more set of coordinates.

### (Supplementary Note 4)

The method of processing the input image according to Supplementary Note 1, wherein the confidence score is compared against a threshold, such that the projected and direct keypoints are rejected if the confidence score is lower than the threshold.

### (Supplementary Note 5)

A method of training a model rendering for an input image, comprising:
obtaining, by a processor, a projected keypoint and a direct keypoint of each feature of the input image, wherein the projected keypoint comprises a first set of coordinates of each feature projected from a 3D rendering of the input image, and the direct keypoint comprises a second set of coordinates of each feature based on a 2D rendering of each feature;
computing, by the processor, a consistency loss value of each feature based on the respective projected keypoint and direct keypoint;
calculating, by the processor, a total loss based on the consistency loss value of each feature and ground truth data of the input image, and deriving a total loss error based on the total loss; and
propagating, by the processor, the total loss error to the model rendering.

### (Supplementary Note 6)

The method of training the model rendering for an input image according to Supplementary Note 5, further comprising obtaining a visibility value of the direct keypoint, wherein the visibility value is computed by the 2D rendering, wherein computing the consistency loss further comprises applying a formula with the visibility value, the projected keypoint and the direct keypoint.

### (Supplementary Note 7)

The method of training the model rendering for an input image according to Supplementary Note 5, wherein the 2D rendering is a heatmap rendering, wherein the heatmap rendering of the feature comprises one or more set of coordinates for each feature, each of the one or more set of coordinates having a probability value, and wherein the second set of coordinates has a highest probability value among the one or more set of coordinates.

### (Supplementary Note 8)

The method of training the model rendering for an input image according to Supplementary Note 6, wherein the processor further obtains a 3D keypoint of each feature from the 3D rendering of the input image.

### (Supplementary Note 9)

The method of training the model rendering for an input image according to Supplementary Note 8, wherein the ground truth data comprises a ground truth 2D keypoint and a ground truth 3D keypoint, and wherein calculating the total loss further comprises applying a formula comprising:
a 2D projected keypoint loss which corresponds to errors between positions of the projected keypoint and the ground truth 2D keypoint;
a 3D keypoint loss which corresponds to errors between positions of the 3D keypoint and the ground truth 3D keypoint; and
a 2D keypoint loss which corresponds to errors between positions of the direct keypoint and ground truth 2D keypoint.

### (Supplementary Note 10)

The method of training the model rendering for an input image according to Supplementary Note 9, wherein calculating the total loss further comprises applying weights to at least one of the 2D projected keypoint loss, the 3D keypoint loss, the 2D keypoint loss and the consistency loss value.

### (Supplementary Note 11)

An apparatus for processing an input image, comprising:
a memory in communication with a processor, the memory storing a computer program recorded therein, the computer program being executable by the processor to cause the apparatus at least to:
obtain a projected keypoint and a direct keypoint of a feature of the input image, wherein the projected keypoint comprises a first set of coordinates of the feature projected from a 3D rendering of the input image, and the direct keypoint comprises a second set of coordinates of the feature based on a 2D rendering of the feature; and
compute a confidence score based on the projected keypoint and the direct keypoint, wherein a higher confidence score indicates a higher accuracy of the projected and direct keypoints.

### (Supplementary Note 12)

The apparatus for processing the input image according to Supplementary Note 11, wherein the memory and the computer program are executed by the processor to cause the apparatus further to:
obtain a visibility value of the direct keypoint, wherein the visibility value is computed by the 2D rendering, and wherein computing the confidence score further comprises applying a formula with the visibility value, the projected keypoint and the direct keypoint.

### (Supplementary Note 13)

The apparatus for processing the input image according to Supplementary Note 12, wherein the 2D rendering is a heatmap rendering, wherein the heatmap rendering of the feature comprises one or more set of coordinates for the feature, each of the one or more set of coordinates having a probability value, and wherein the second set of coordinates has a highest probability value among the one or more set of coordinates.

### (Supplementary Note 14)

The apparatus for processing the input image according to Supplementary Note 11, wherein the memory and the computer program are executed by the processor to cause the apparatus further to:
compare the confidence score against a threshold, such that the projected and direct keypoints are rejected if the confidence score is lower than the threshold.

### (Supplementary Note 15)

An apparatus for training a model rendering for an input image, comprising:
a memory in communication with a processor, the memory storing a computer program recorded therein, the computer program being executable by the processor to cause the apparatus at least to:
obtain a projected keypoint and a direct keypoint of each feature of the input image, wherein the projected keypoint comprises a first set of coordinates of each feature projected from a 3D rendering of the input image, and the direct keypoint comprises a second set of coordinates of each feature based on a 2D rendering of each feature;
compute a consistency loss value of each feature based on the respective projected keypoint and the direct keypoint;
calculate a total loss based on the consistency loss value of each feature and ground truth data of the input image, and deriving a total loss error based on the total loss; and
propagate the total loss error to the model rendering.

### (Supplementary Note 16)

The apparatus for training a model rendering for an input image according to Supplementary Note 15, wherein the memory and the computer program are executed by the processor to cause the apparatus further to:
obtain a visibility value of the direct keypoint, wherein the visibility value is computed by the 2D rendering, and wherein computing the consistency loss value further comprises applying a formula with the visibility value, the projected keypoint and the direct keypoint.

### (Supplementary Note 17)

The apparatus for training a model rendering for an input image according to Supplementary Note 16, wherein the 2D rendering is a heatmap rendering, wherein the heatmap rendering of the feature comprises one or more set of coordinates for the feature, each of the one or more set of coordinates having a probability value, and wherein the second set of coordinates has a highest probability value among the one or more set of coordinates.

### (Supplementary Note 18)

The apparatus for training a model rendering for an input image according to Supplementary Note 15, wherein the memory and the computer program are executed by the processor to cause the apparatus further to:
obtain a 3D keypoint of each feature from the 3D rendering of the input image.

### (Supplementary Note 19)

The apparatus for training a model rendering for an input image according to Supplementary Note 18, wherein the ground truth data comprises a ground truth 2D keypoint and a ground truth 3D keypoint, and wherein the memory and the computer program is executed by the processor to cause the apparatus further to calculate the total loss by applying a formula comprising:
a 2D projected keypoint loss which corresponds to errors between positions of the projected keypoint and the ground truth 2D keypoint;
a 3D keypoint loss which corresponds to errors between positions of the 3D keypoint and the ground truth 3D keypoint; and
a 2D keypoint loss which corresponds to errors between positions of the direct keypoint and ground truth 2D keypoint.

### (Supplementary Note 20)

The apparatus for training a model rendering for an input image according to Supplementary Note 19, wherein the memory and the computer program are executed by the processor to cause the apparatus further to:
apply weights to at least one of the 2D projected keypoint loss, the 3D keypoint loss, the 2D keypoint loss and the consistency loss value.
   (Supplementary Note 21) A system for processing an input image, comprising:
the apparatus as claimed in any one of Supplementary Notes 11-14 and at least one image capturing device.
   (Supplementary Note 22) A system for training a model rendering for an input image, comprising:
the apparatus as claimed in any one of Supplementary Notes 15-20 and at least one image capturing device.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention.

This application is based upon and claims the benefit of priority from Singapore patent application No. 10202104691X, filed on May 5, 2021, the disclosure of which is incorporated herein in its entirety by reference.

What is claimed is:

1. A method of processing an input image, comprising:
obtaining, by a processor, a projected keypoint and a direct keypoint of a feature of the input image, wherein the projected keypoint comprises a first set of coordinates of the feature projected from a 3D rendering of the input image, and the direct keypoint comprises a second set of coordinates of the feature based on a 2D rendering of the feature; and
computing, by the processor, a confidence score based on the projected keypoint and the direct keypoint, wherein a higher confidence score indicates a higher accuracy of the projected and direct keypoints.

2. The method of processing the input image according to claim 1, further comprising obtaining a visibility value of the direct keypoint, wherein the visibility value is computed by the 2D rendering, and wherein computing the confidence score further comprises applying a formula with the visibility value, the projected keypoint and the direct keypoint.

3. The method of processing the input image according to claim 2, wherein the 2D rendering is a heatmap rendering, wherein the heatmap rendering of the feature comprises one or more set of coordinates for the feature, each of the one or more set of coordinates having a probability value, and wherein the second set of coordinates has a highest probability value among the one or more set of coordinates.

4. The method of processing the input image according to claim 1, wherein the confidence score is compared against a threshold, such that the projected and direct keypoints are rejected if the confidence score is lower than the threshold.

5-10. (canceled)

11. An apparatus for processing an input image, comprising:
a memory in communication with a processor, the memory storing a computer program recorded therein, the computer program being executable by the processor to cause the apparatus at least to:
obtain a projected keypoint and a direct keypoint of a feature of the input image, wherein the projected keypoint comprises a first set of coordinates of the feature projected from a 3D rendering of the input image, and the direct keypoint comprises a second set of coordinates of the feature based on a 2D rendering of the feature; and
compute a confidence score based on the projected keypoint and the direct keypoint, wherein a higher confidence score indicates a higher accuracy of the projected and direct keypoints.

12. The apparatus for processing the input image according to claim 11, wherein the memory and the computer program are executed by the processor to cause the apparatus further to:
obtain a visibility value of the direct keypoint, wherein the visibility value is computed by the 2D rendering, and wherein computing the confidence score further comprises applying a formula with the visibility value, the projected keypoint and the direct keypoint.

13. The apparatus for processing the input image according to claim 12, wherein the 2D rendering is a heatmap rendering, wherein the heatmap rendering of the feature comprises one or more set of coordinates for the feature, each of the one or more set of coordinates having a probability value, and wherein the second set of coordinates has a highest probability value among the one or more set of coordinates.

14. The apparatus for processing the input image according to claim 11, wherein the memory and the computer program are executed by the processor to cause the apparatus further to:
compare the confidence score against a threshold, such that the projected and direct keypoints are rejected if the confidence score is lower than the threshold.

15.-20. (canceled)

21. A non-transitory computer-readable storage medium storing a program for causing a computer to execute processing comprising:
obtaining a projected keypoint and a direct keypoint of a feature of the input image, wherein the projected keypoint comprises a first set of coordinates of the feature projected from a 3D rendering of the input image, and the direct keypoint comprises a second set of coordinates of the feature based on a 2D rendering of the feature; and
computing a confidence score based on the projected keypoint and the direct keypoint, wherein a higher confidence score indicates a higher accuracy of the projected and direct keypoints.

22. The non-transitory computer-readable storage medium storing the program for causing the computer to execute the processing according to claim 22, the processing further comprising obtaining a visibility value of the direct keypoint, wherein the visibility value is computed by the 2D rendering, and wherein computing the confidence score further comprises applying a formula with the visibility value, the projected keypoint and the direct keypoint.

23. The non-transitory computer-readable storage medium storing the program for causing the computer to execute the processing according to claim 23, wherein the 2D rendering is a heatmap rendering, wherein the heatmap rendering of the feature comprises one or more set of coordinates for the feature, each of the one or more set of coordinates having a probability value, and wherein the second set of coordinates has a highest probability value among the one or more set of coordinates.

24. The non-transitory computer-readable storage medium storing the program for causing the computer to execute the processing according to claim 21, wherein the confidence score is compared against a threshold, such that the projected and direct keypoints are rejected if the confidence score is lower than the threshold.
